(19) United States
(12) Patent Application Publication
(10) Pub. No.: US 2002/0073015 A1
(43) Pub. Date: Jun. 13, 2002

(54) Method and system for trading redeemable assets

(76) Inventors: Hiok Khiang Chan, Kuala Lumpur (MY); Hong Leong Chee, Kuala Lumpur (MY); Kher Tean Chen, Johor (MY); Yeow Leong Chong, Petaling Jaya (MY); Kong Meng Lee, Kuala Lumpur (MY); Yuong Wah Looi, Kuala Lumpur (MY); Stuart Royston Ockenden, Kuala Lumpur (MY); Joon Suan Tan, Selangor (MY); William Mark Bingham, Lancaster (GB); Kwang Leh Wong, Kuala Lumpur (MY); Poi Leong Yong, Kuala Lumpur (MY)

Correspondence Address: LADAS & PARRY, 224 SOUTH MICHIGAN AVENUE, SUITE 1200, CHICAGO, IL, 60604, US

(21) Appl. No.: 09/864,743

(22) Filed: May 24, 2001

(30) Foreign Application Priority Data
Dec. 8, 2000 (MY) PI 2000 5764

(51) Int. Cl. G06F 17/60

(52) U.S. Cl. 705/37

(57) ABSTRACT

The present invention establishes an online market place bringing together owners, developers/operators, trustees, associations, and management companies of redeemable assets. Through an asset converter, redeemable assets are evaluated online or offline according to a points-based system and the value of assets are converted to digital tokens before trading takes place. A separate and independent asset validator that is linked to the asset converter, asset management companies as well as asset developers/operators acts as a caretaker in verifying the status of ownership of assets and ensures the delivery, receipt and utilization rights of the assets. Digital tokens are indicia of the value of redeemable assets and may be spent only within the market place of the present invention. As such, trading and exchange of redeemable assets among different classes and types are carried out virtually, transparently and securely.

### FIELD OF THE INVENTION

The present invention relates to a method and system for trading redeemable assets. In particular, the present invention pertains to an online method and system for converting and realizing the intrinsic value of assets such as timeshare intervals, frequent mileage points, credit card loyalty points, hotel rewards programs and other time sensitive yet valuable assets.

### BACKGROUND OF THE INVENTION

Billions of dollars of financial assets such as currencies, stock and bonds are converted and traded globally everyday. Such transactions dwarfed the volume of global physical trade. Yet there is a large pool of redeemable assets that many consumers own but whose intrinsic values are not easily converted or realized when not used. Even if such redeemable assets were sold, the owners usually sustain a significant drop in value compared with the original purchase price.

By redeemable assets, the present invention refers to a broad category of assets such as timeshare intervals, holiday villa stays, luxury yachts, houseboats, frequent mileage points, credit card loyalty points, hotel rewards programs and other time sensitive and valuable assets that are hitherto not conveniently convertible or traded without significant depreciation. A common feature of redeemable assets is the illiquid nature of the underlying right: asset owners of redeemable assets are restricted from converting or trading them for other assets outside the domain of the developer/operator of such assets. In the past, redeemable assets are time sensitive; assets owners are given a specific time period to exercise their redemption rights beyond which the assets will lapse. Recently, developers of redeemable assets have removed such time sensitive restriction to render them more attractive to asset owners.

The non-convertibility of redeemable assets has given birth to many companies that facilitate the conversion and realization of such redeemable assets. Although the market leaders have membership well over one million subscribers, owners or members, the process of converting redeemable assets much less realizing the intrinsic value thereof in this particular example is far from smooth.

For example in timeshare intervals, common complaints are delays in confirming a match of suitable resort location or unavailability of timeshare intervals preferred by the asset owner. For those who are prone to make last minute travel plans or change their minds at the eleventh hour, it is virtually impossible for one to exchange one's redeemable assets for another like kind of assets.

In varying circumstances, the values of timeshare interval exchanges are not always equal and fair and therefore, to the dissatisfaction of the timeshare interval owners.

More importantly, redeemable asset owners often have to telephone the offices of timeshare companies, resorts and timeshare exchange providers to confirm exchange of timeshare intervals. The process of exchanging timeshare intervals is far from dear and transparent, and is often restricted to the office hours of timeshare companies, resorts and timeshare exchange providers.

Recently, U.S. Pat. No. 5,926,793 discloses a digital timeshare exchange where the analog procedures of traditional timeshare exchange companies are incorporated in an online fashion. While the operational hours of such a digital timeshare exchange are around the clock the kind of assets being exchanged is confined to timeshare intervals.

More recently, e-commerce portals such as Milepoint.com enable members to purchase a range of products from participating vendors with their mileage points or MilePoint Money as partial payment. Under the Milepoint.com scheme, redeemable assets like frequent mileage are converted partially as a discount coupon for subscribing members to trade or exchange for products that they wish to purchase. Once again, the direct or non-monetary exchange of products/services for one's redeemable assets remain elusive.

Even more recently, BarterExpress.com introduces a new website trade hub that allows members to offer any products or services that they wish to sell by quoting the sale price in Trade Dollars (T$) through a clearing house or trading room. Fellow BarterExpress members can purchase your product or service by going through an online purchasing process. If a transaction to sell and buy is not cancelled for a pending period of five days, the T$ is deducted from buyer's account and transferred to seller's account. At this point, BarterExpress charges the seller a commission of no more than five percent of the value of the items being sold in cash. Credit line is available for members under certain circumstances.

Although some of the recent e-commerce solutions for exchanging, trading or bartering have gone some ways in alleviating the illiquidity of redeemable assets, in the main most of the digital exchanges are cumbersome and make internet transactions more of a hassle than a convenience. As such, any hope of building a critical mass of inventory of such redeemable assets remains unfulfilled.

### OBJECT OF THE INVENTION

It is an object of the present invention to create an electronic marketplace to facilitate the transfer and trade of redeemable assets with minimal monetary intermediary.

It is another object of the present invention to facilitate the transfer and trade of redeemable assets among different values and types.

It is yet another object of the present invention to offer individual asset owners a universal and transparent platform for conducting transfer and trade of redeemable assets online and automatically.

It is a further object of the present invention to permit individual asset owners to convert redeemable assets into digital tokens before they decide to transfer or trade the same.

It is also another object of the present invention to centralize the verification and monitoring of redeemable assets to minimize risks in delivery, receipt and utilization rights of such assets.

It is yet a further object of the present invention to extend the privileges of trading of redeemable assets to asset developers, managers and operators and also to permit one-to-one swapping of assets among exclusive assets owners in order to optimize inventory utilization.

### SUMMARY OF THE INVENTION

The present invention establishes an online market place bringing together owners, developers, operators, managers and intermediaries of a variety of redeemable assets. Through an asset converter, redeemable assets are evaluated online or offline according to a points-based system and the value of assets are converted to digital tokens before trading takes place. An independent but not necessarily separate asset validator that is linked to the asset converter acts as a caretaker in verifying the status of ownership of assets and ensures the delivery, receipt and utilization rights of the assets. Digital tokens are indicia of the value of redeemable assets and may be spent only within the market place of the present invention. As such, trading of redeemable assets among different classes and types are carried out virtually, transparently and securely.

### BRIEF DESCRIPTION OF THE DRAWINGS

FIG. 1 is an architectural overview of the present invention illustrating the relationship among the individual asset owners, the asset converter, the asset validator and the asset developers.

FIG. 2 shows graphically the steps of registering an individual asset owner while interfacing with asset converter of the present invention.

FIGS. 2A-2C presents in diagrams the process of calculating a points-based or token system for the underlying physical asset and duly adjusted for seasonal and other relevant factors.

FIG. 3 is illustrative of the steps for an individual asset owner to convert a redeemable asset with the asset converter of the present invention.

FIG. 4 is representative of the process for an individual asset owner to search and buy a redeemable asset with the asset converter of the present invention.

FIGS. 4A-4L are illustrative interfaces of the asset converter of the present invention showing the process of an individual asset owner buying three redeemable assets and paying with a credit card.

FIG. 5 presents in block diagrams illustrating the steps of an enhanced one-to-one swap of redeemable assets of exclusive, high quality timeshare resorts with the asset converter of the present invention.

FIG. 6 shows in block diagrams the steps for asset developers to offer on a consignment basis sale of redeemable assets with the asset converter of the present invention.

### DETAILED DESCRIPTION OF THE INVENTION

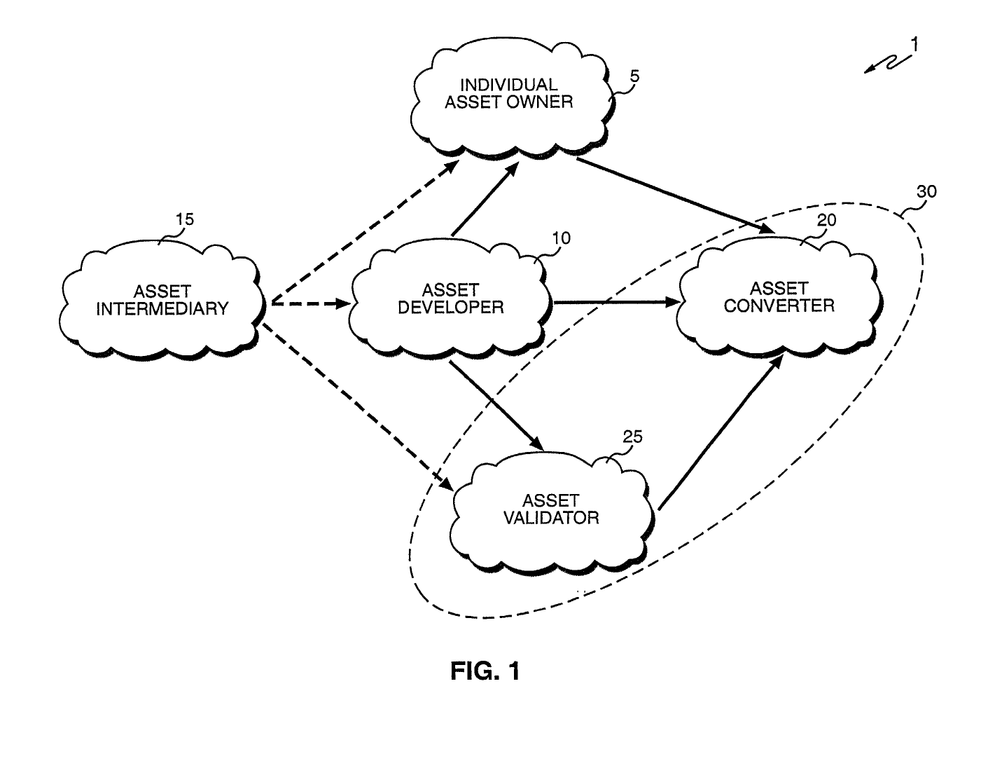

As described in FIG. 1, the present invention establishes a secured, online market place 1 for the transparent conversion of trading of redeemable assets. In this new online market place, there are at least four categories of participants: individual owners 5, developers 10, asset intermediary 15, asset converter 20 and optionally an asset validator. The owners 5 are purchasers or beneficiaries of redeemable assets such as timeshare intervals of resorts, frequent mileage points, vacation slots, credit card loyalty points, hotel rewards programs and others. The asset developers are proprietors who developed holiday resorts, franchisers of credit cards or similar financial instruments, or airline administrators of frequent mileage program & etc. The asset intermediary 15 encompasses a large group of players such as asset management companies, asset operators, custodians of assets, association of timeshare owners and just about any middle person entrusted with the management and handling of redeemable assets. Reference is made in the background section above that a handful of redeemable asset service providers have been providing the services and mechanism for the acquisition and exchange of such assets as well as the attendant shortcoming of such arrangement.

Referring again to FIG. 1, the present invention establishes the new and secured asset converter 20 that facilitates the conversion of redeemable assets of the asset owners 5 into assets that realizes their intrinsic value. As will be shown later, the present invention also encourages the asset developers 10 to execute consignment sale of redeemable assets via the asset converter 20 in maximizing the utilization of their own inventory of redeemable assets. The asset converter 20 is further linked to the asset validator 25 that verifies the status of ownership and transferability of redeemable assets that the asset owners submit through the asset converter 20. With input and confirmation from the asset developers 10 and/or the asset intermediary 15, the asset validator 25 closes the information gap that the asset converter 20 needs to enable the asset owner from converting one asset to another in the least amount of time. Preferably, such response shall be as close to real time as possible; therefore, the asset owners 5 will experience the true feeling of being connected to an online system. Although the asset converter 20 and the asset validator 25 are shown to be distinct entities, they need not be so. As long as the asset validator 25 is considered by the asset owners 5, the asset developers 10 and the asset intermediary 15 to be legally and fiduciary-wise independent, the asset converter 20 and the asset validator 25 can be physically or structurally located in the same location as depicted graphically as entity 30 in FIG. 1.

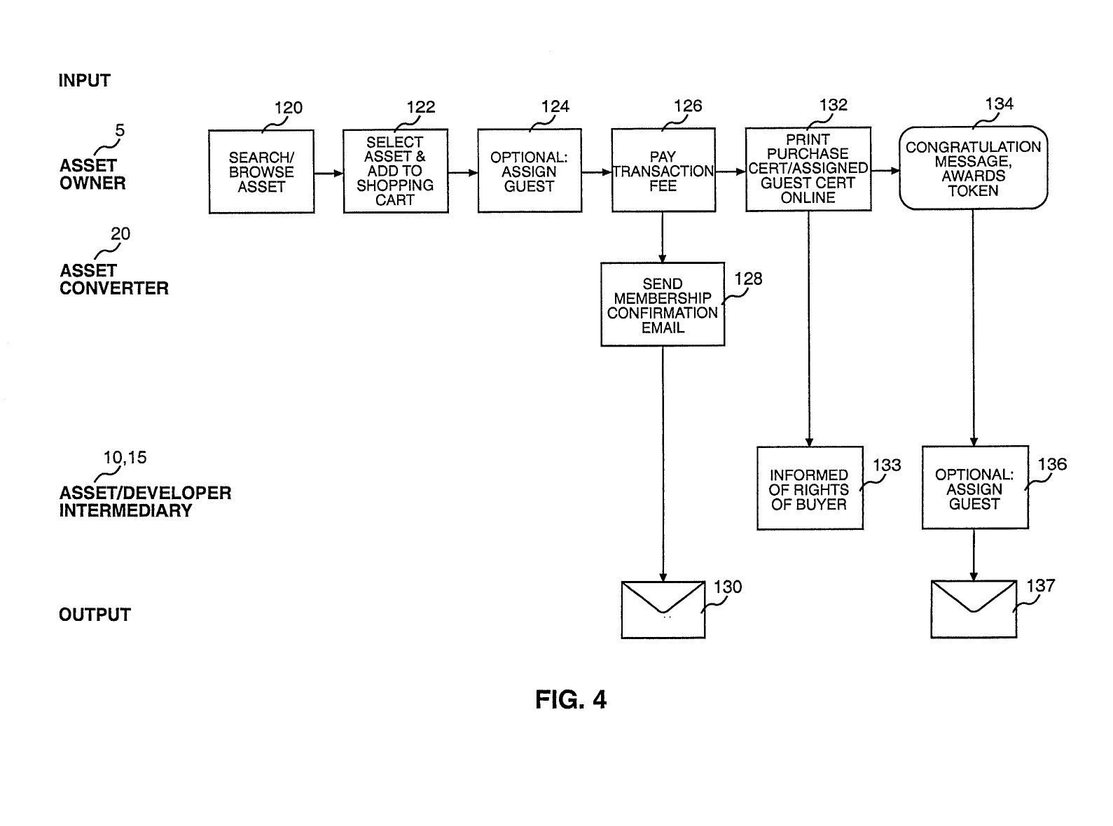

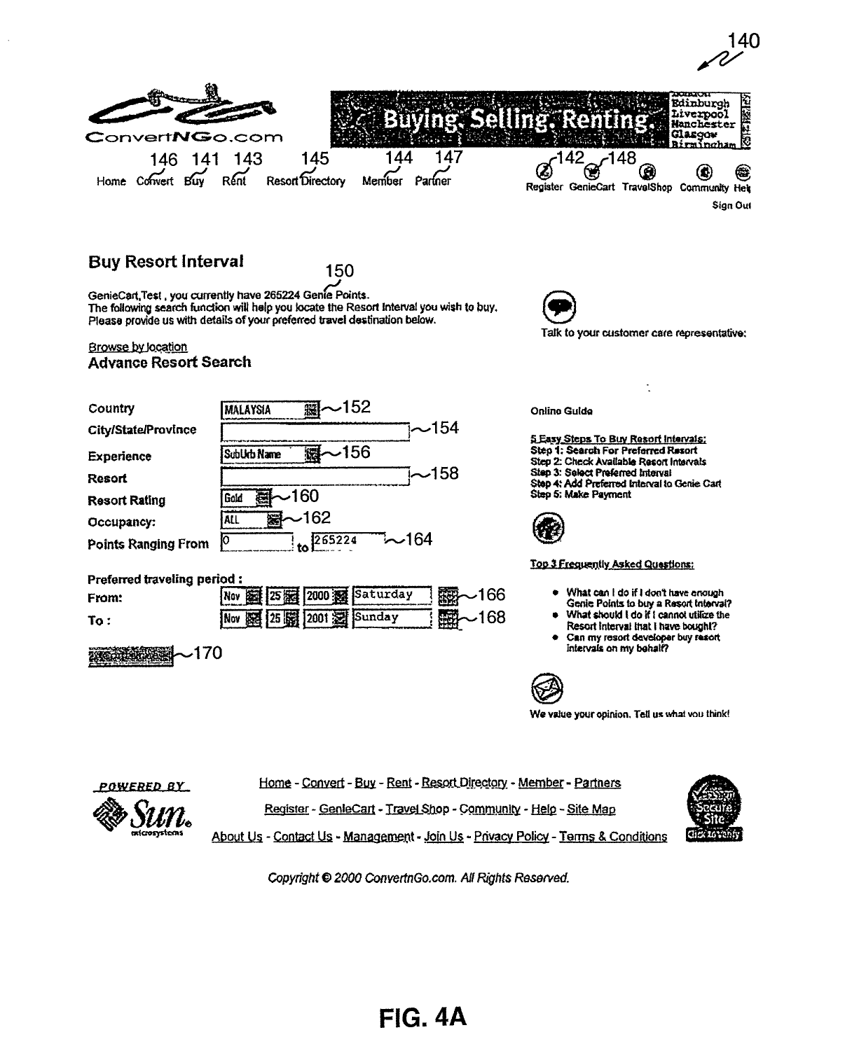

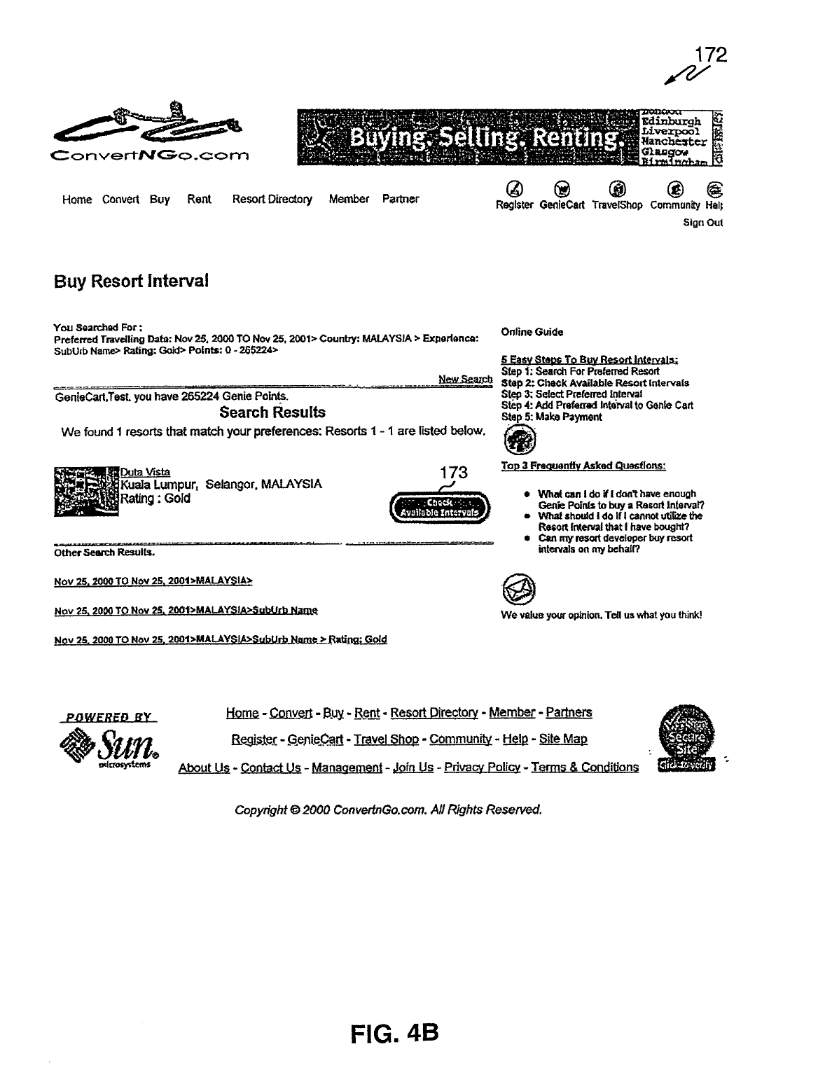

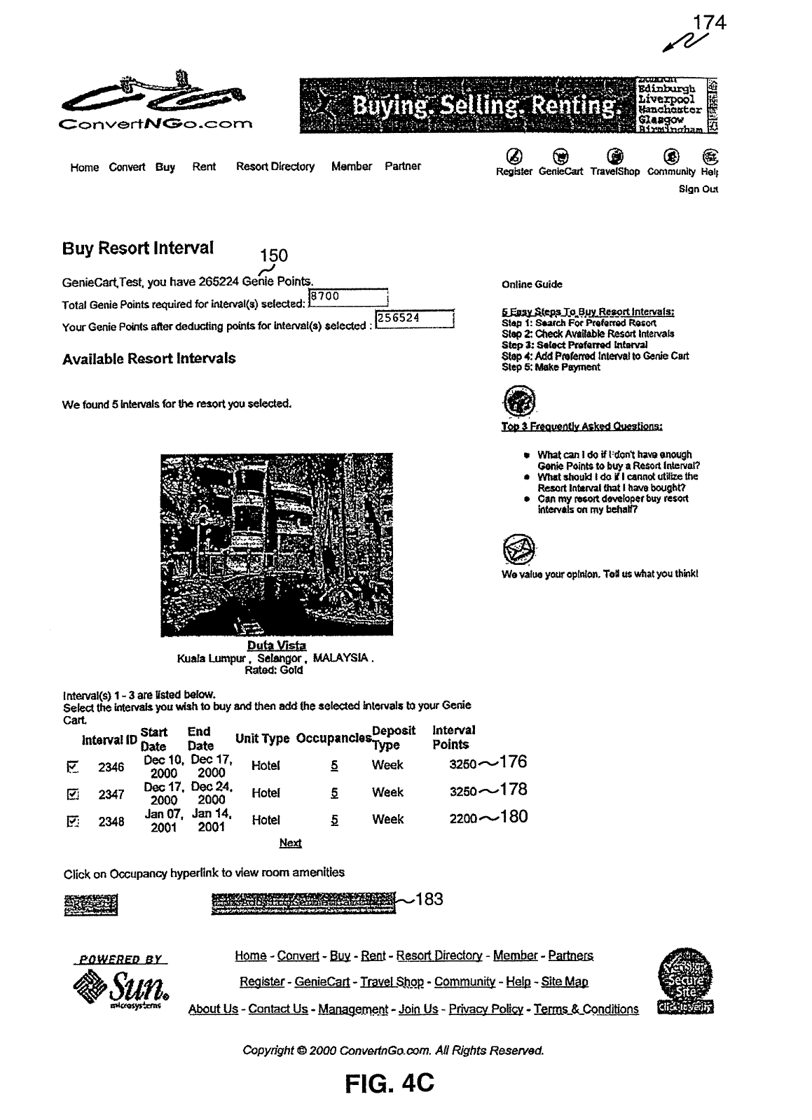

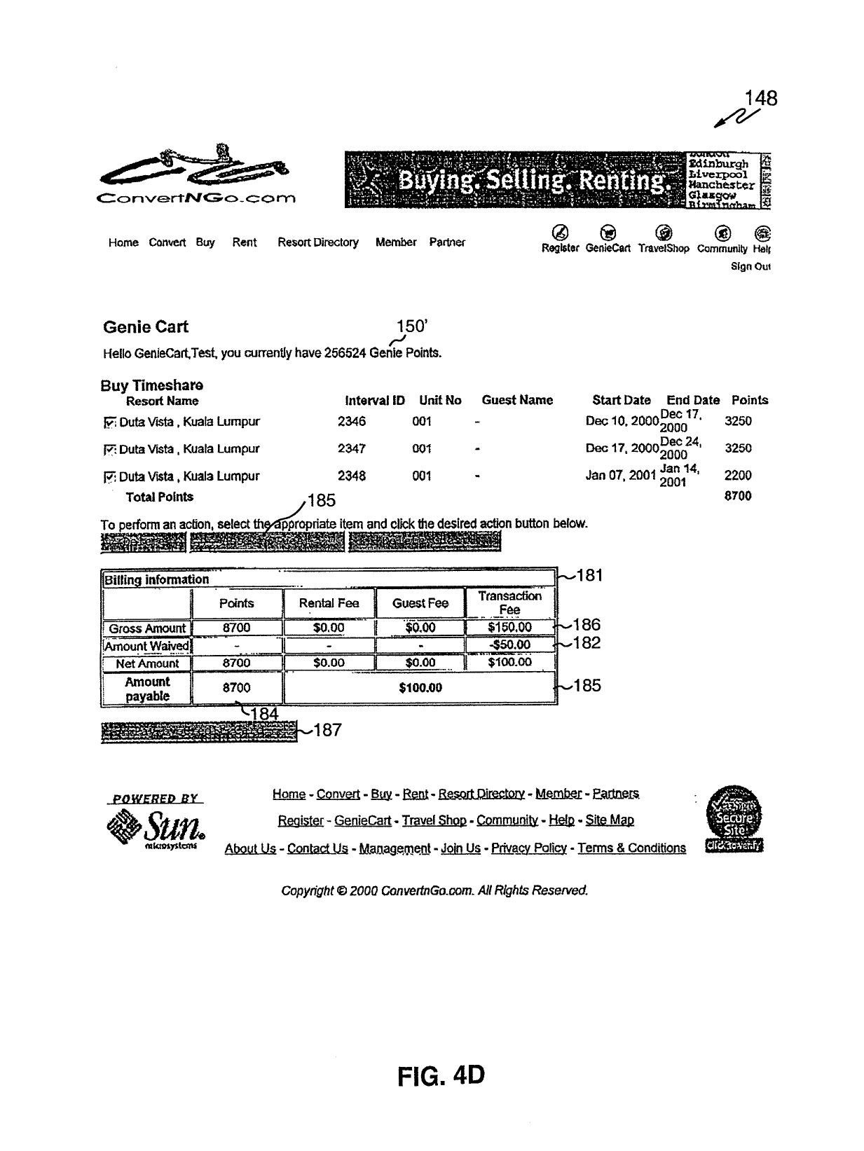

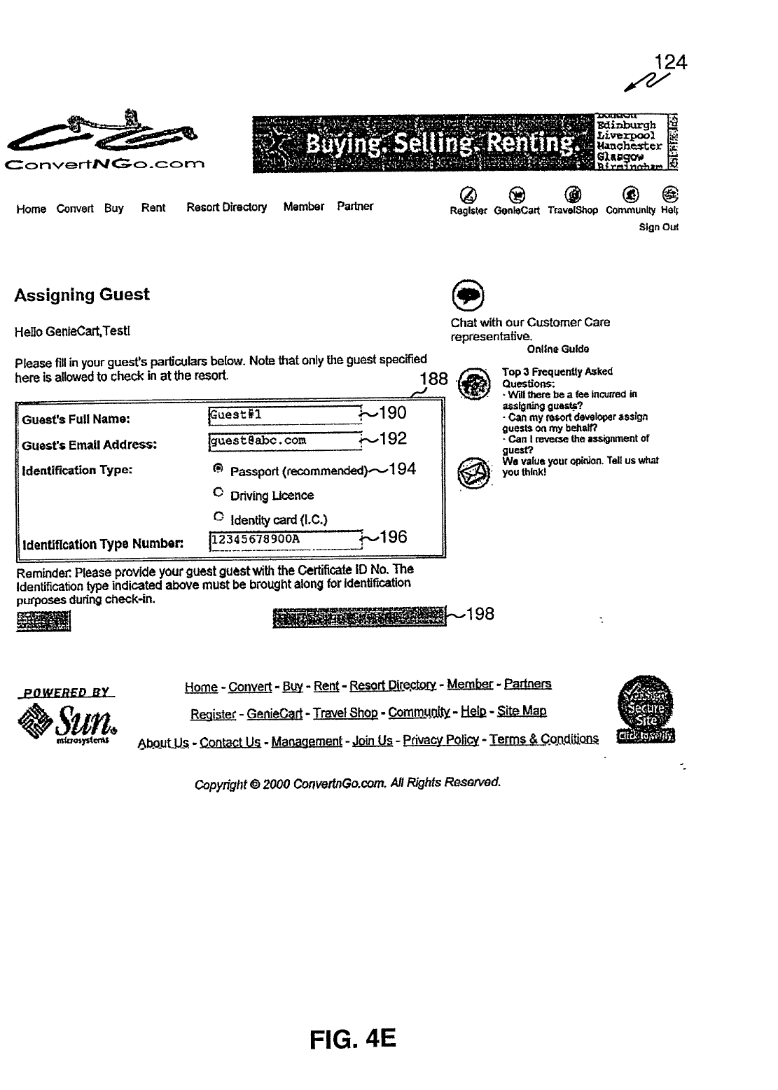

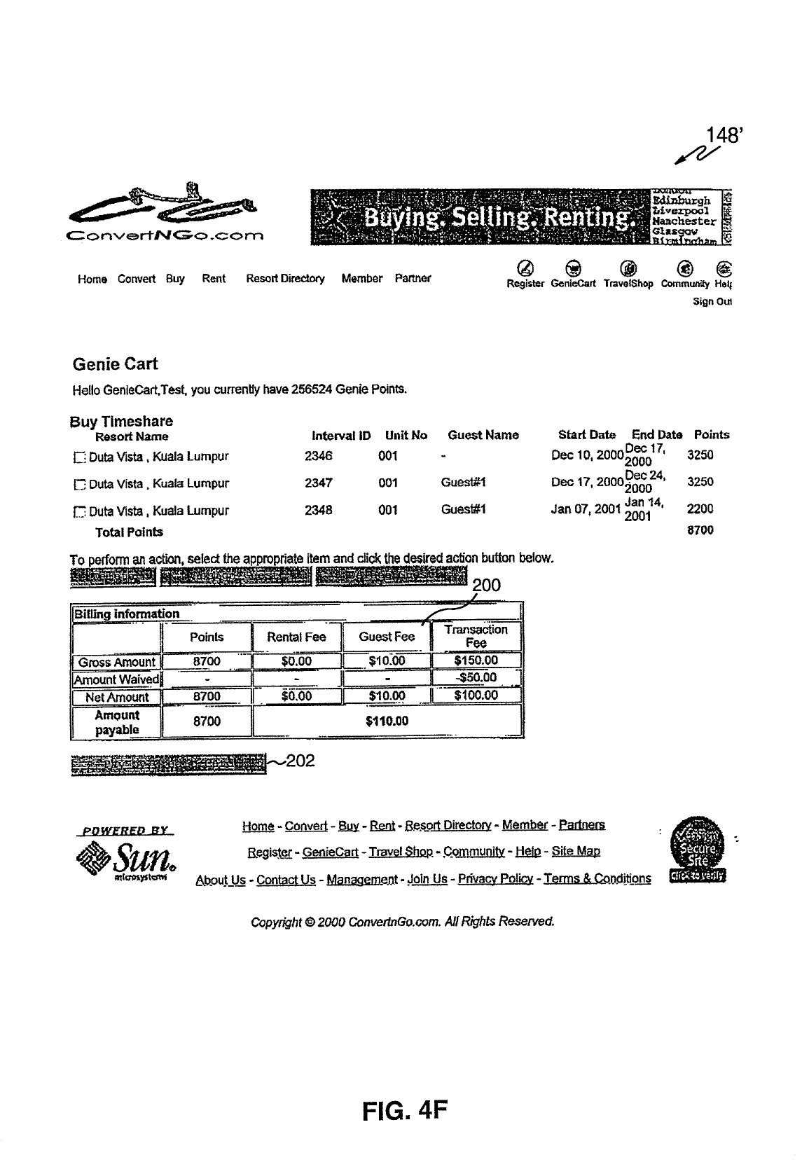

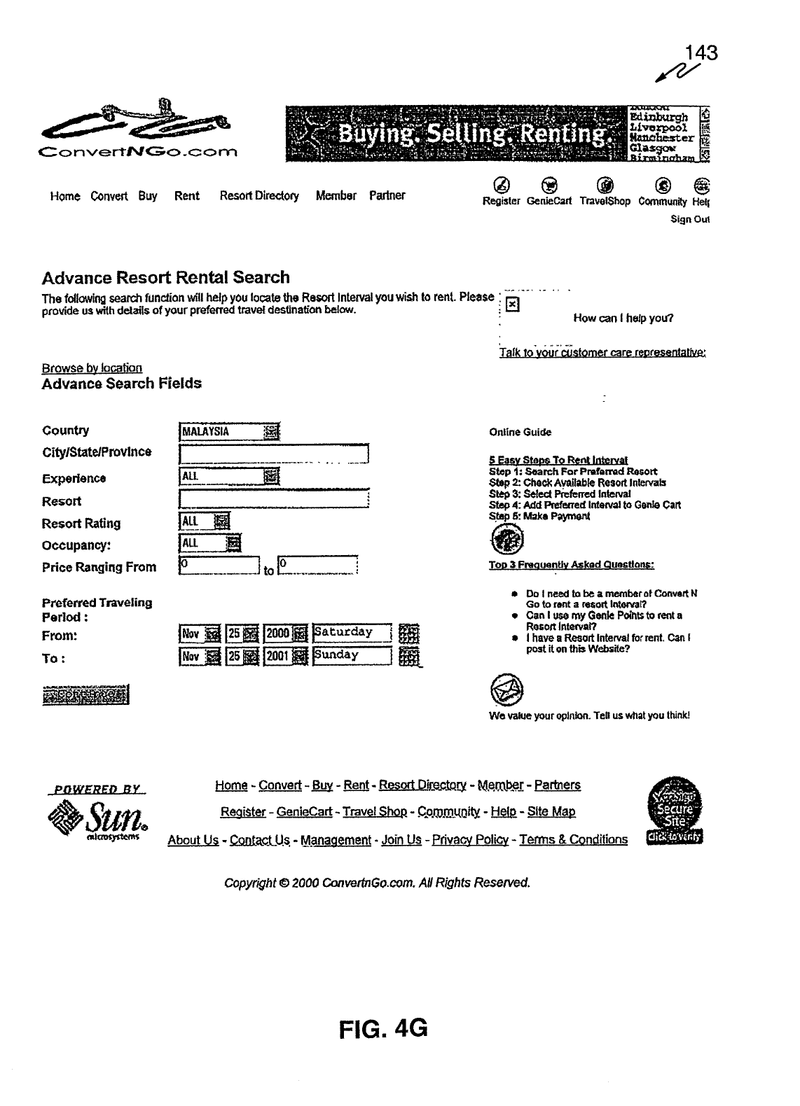

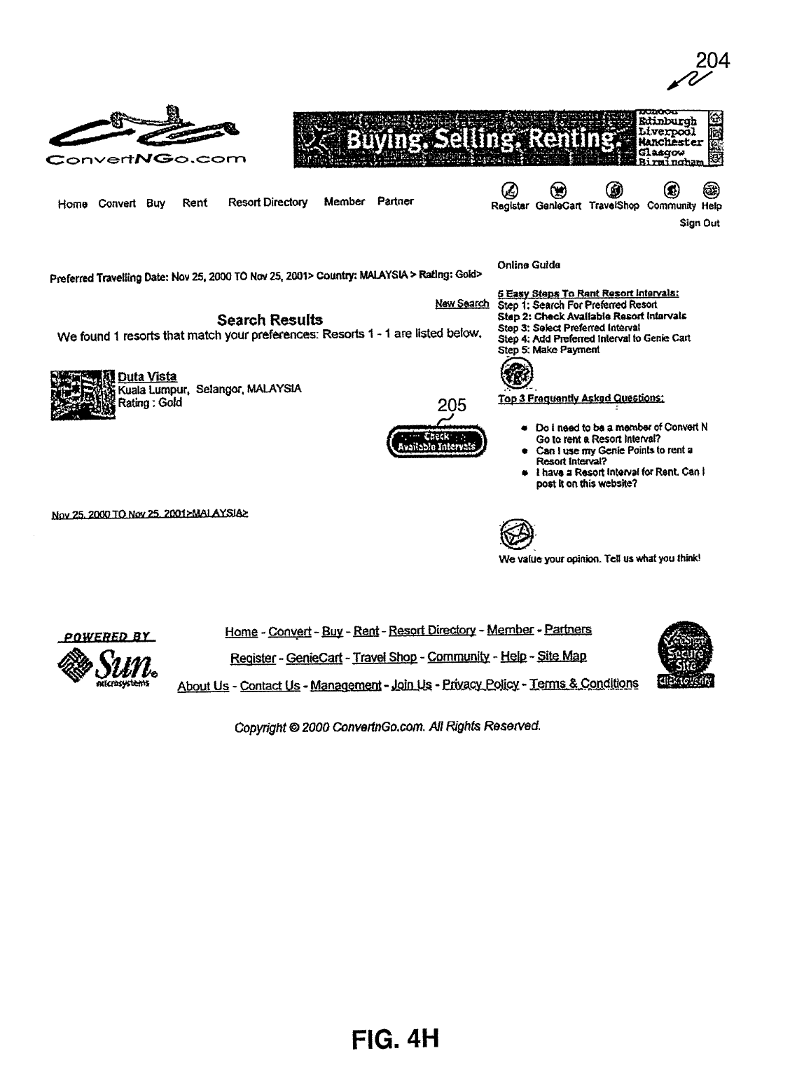

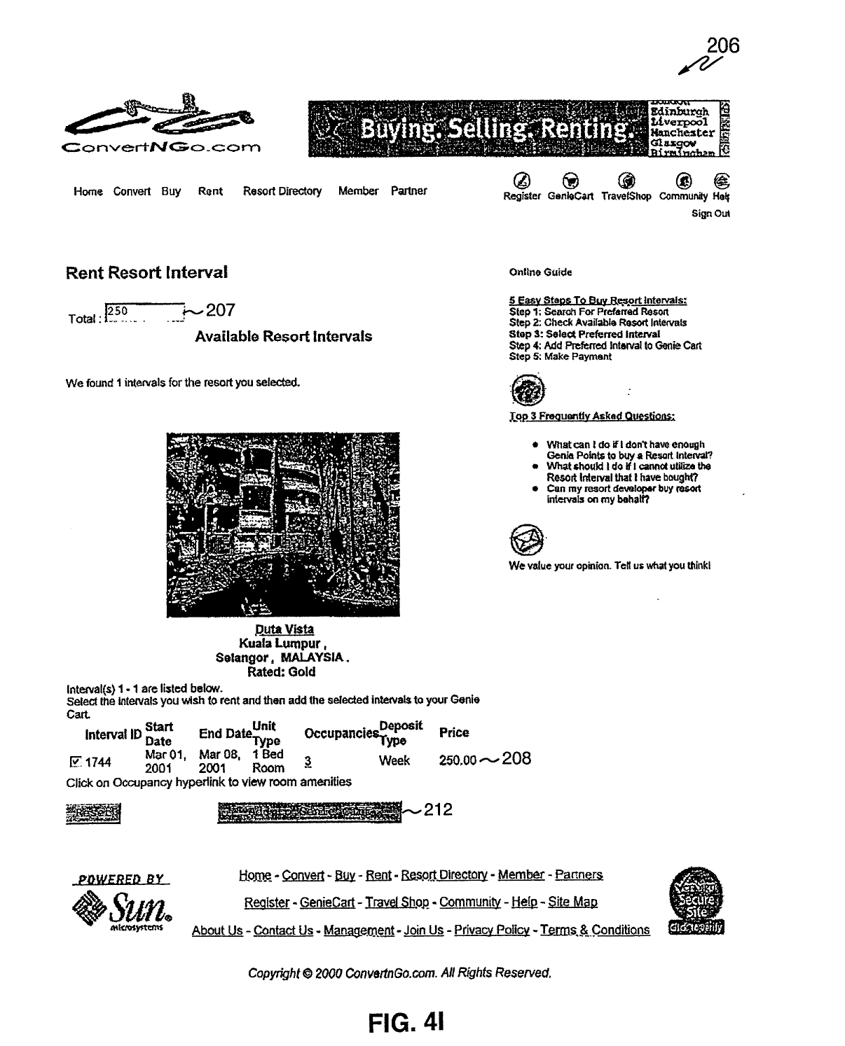

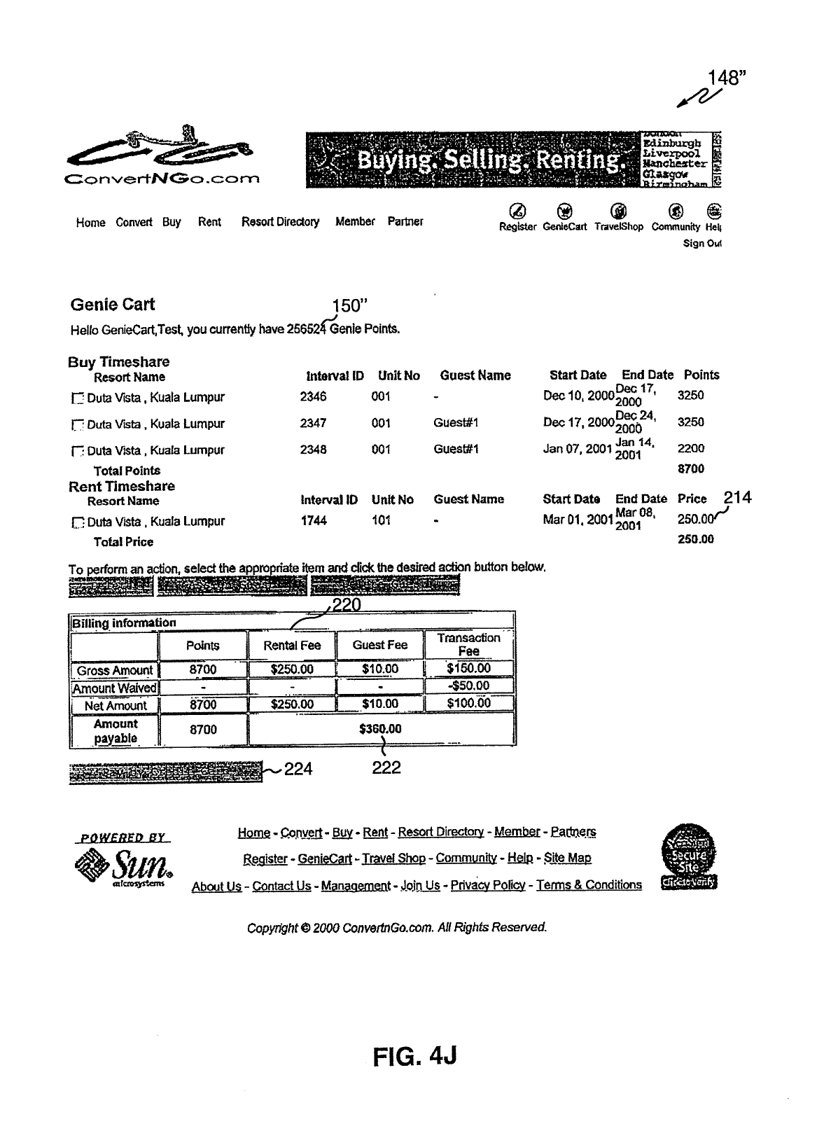

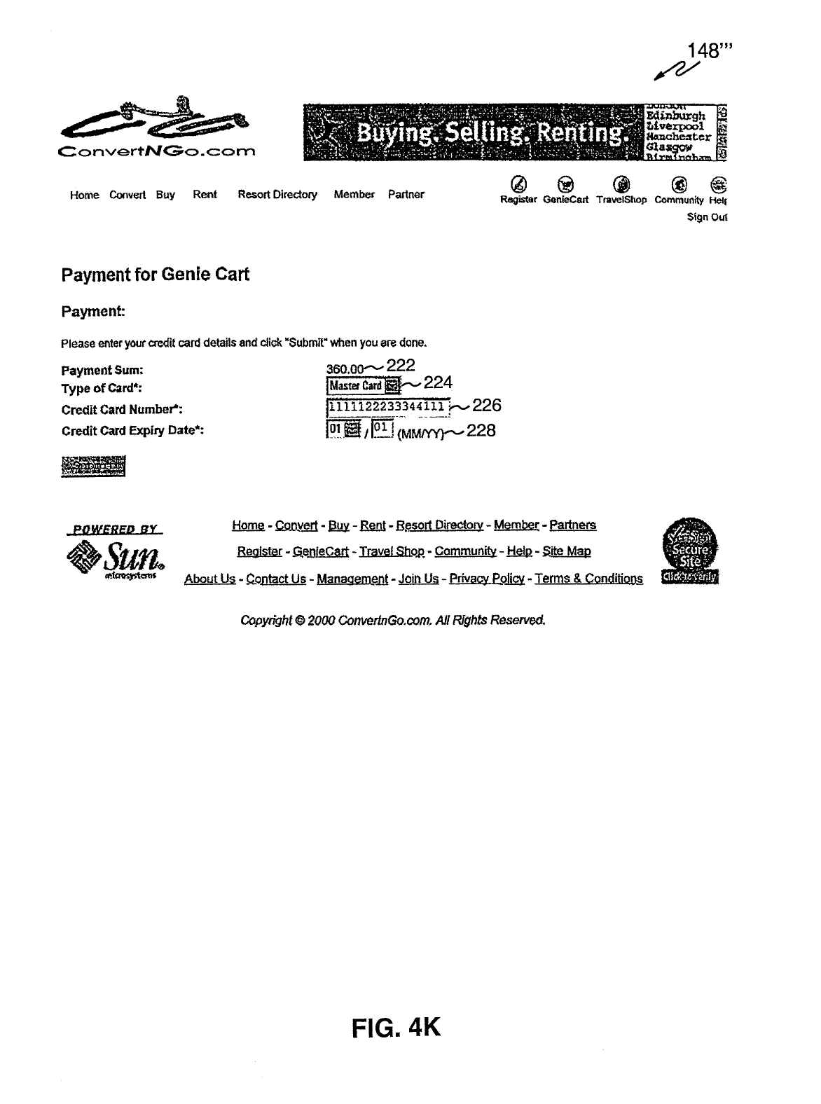

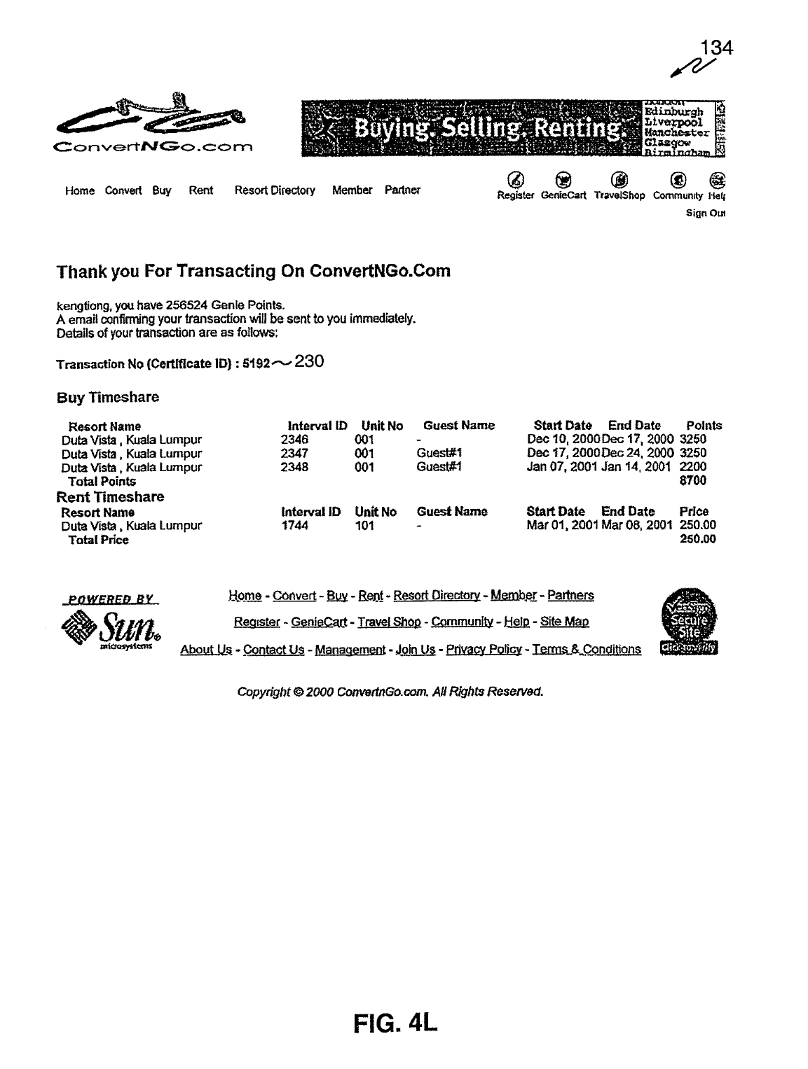

Again in FIG. 1, the asset converter 20 comprises a server (not shown in figures) having at least one data storage repository for storing records of the individual asset owners 5. The asset owners 5 are connected to the asset converter 20 via a communication channel known to persons skilled in the art. In an online context, this communication channel is the internet. It is also envisaged that such communication link can be a satellite or wireless links. As will be shown in FIGS. 4A-4L, the asset converter 20 has a user-friendly interface or website that permits the asset owners to conduct a variety of services therewith. Similarly, the asset validator 25 has substantially similar hardware, software, database and interface as the asset converter 20. Except, the asset validator has communication links with the asset developers 10 and the asset intermediary 15. It should also be understood by one skilled in the art that the asset developers 10 and the asset intermediary 15 have similar communication linkage with the asset converter 20 as the asset owners 5.

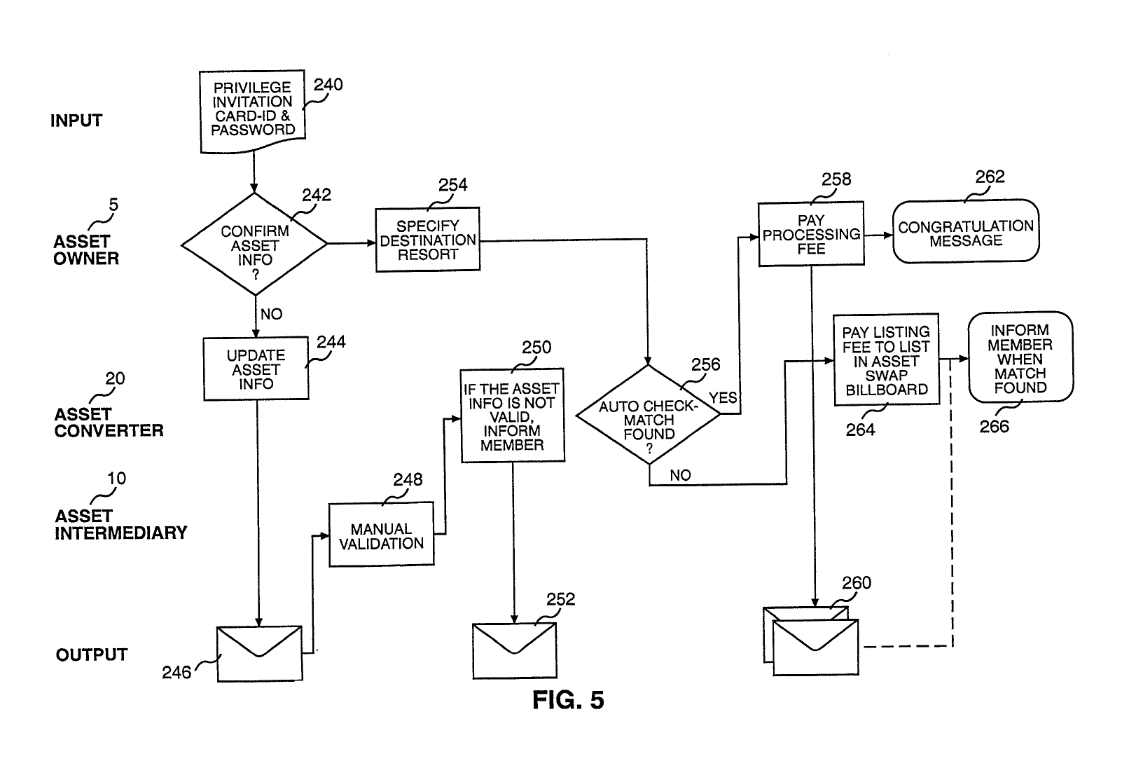

In FIG. 1, the communication links among the asset intermediary 15 with the asset owners 5, the developer 10, and the validator/converter are shown as dotted lines. The reason is that the asset developer 10 as described in FIG. 5, may not have any relationship with any asset intermediary. For instance, certain exclusive asset developers 10 may choose to communicate directly with the asset owners 5. Alternatively, the asset converter 20 may only communicate with the asset developer 10 in verifying the registered owners and rights to redeemable assets.

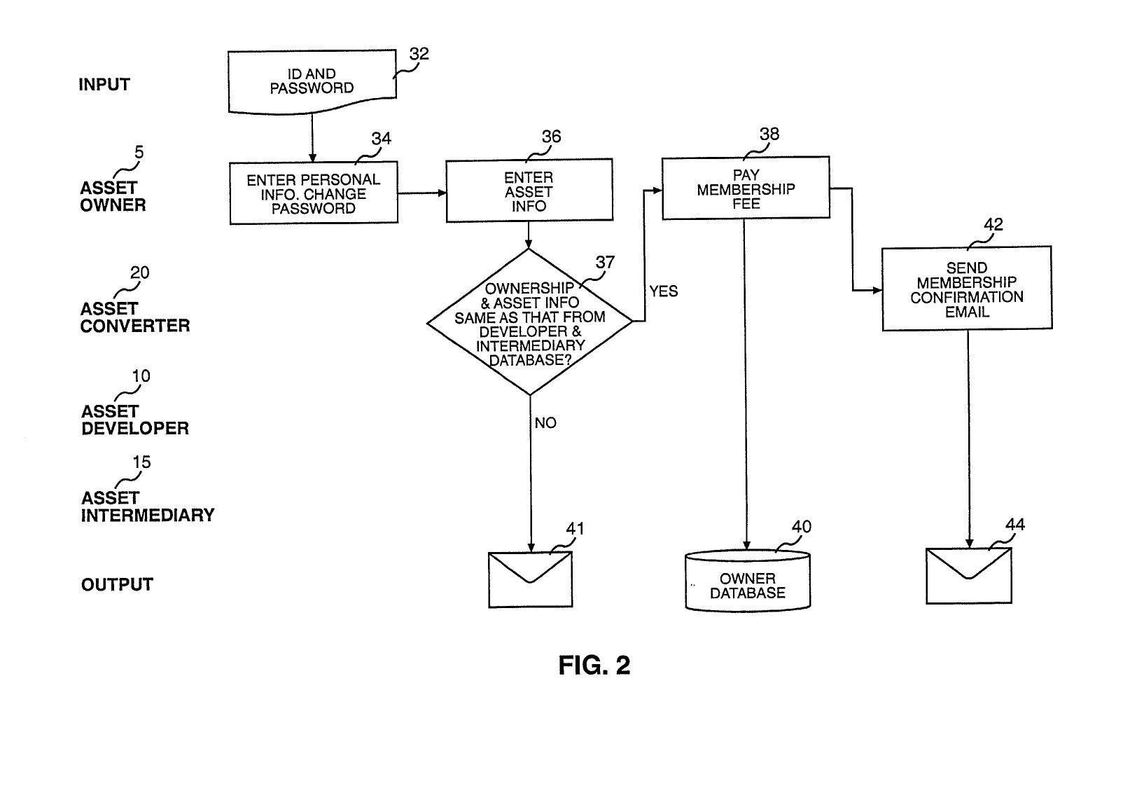

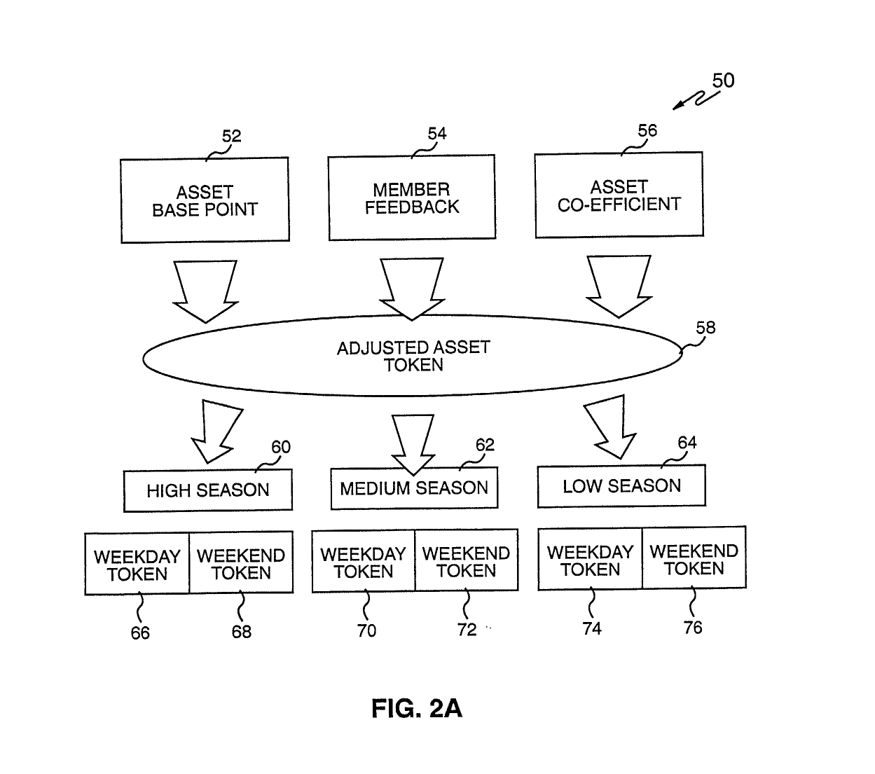

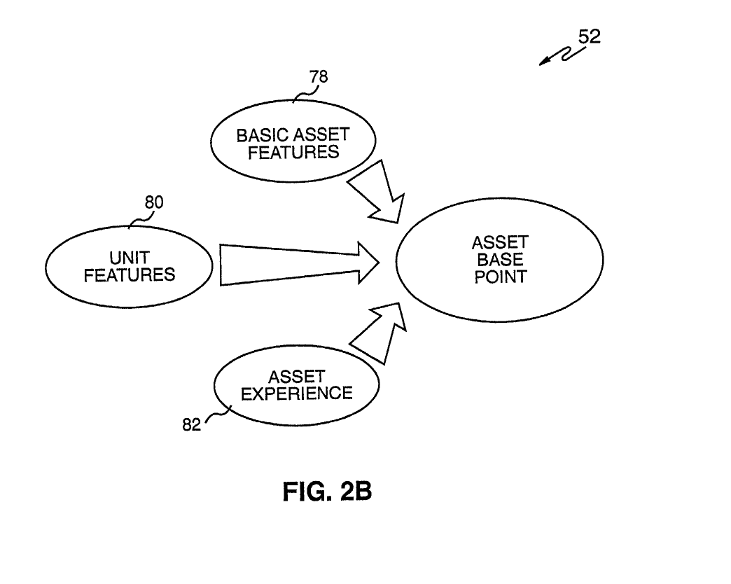

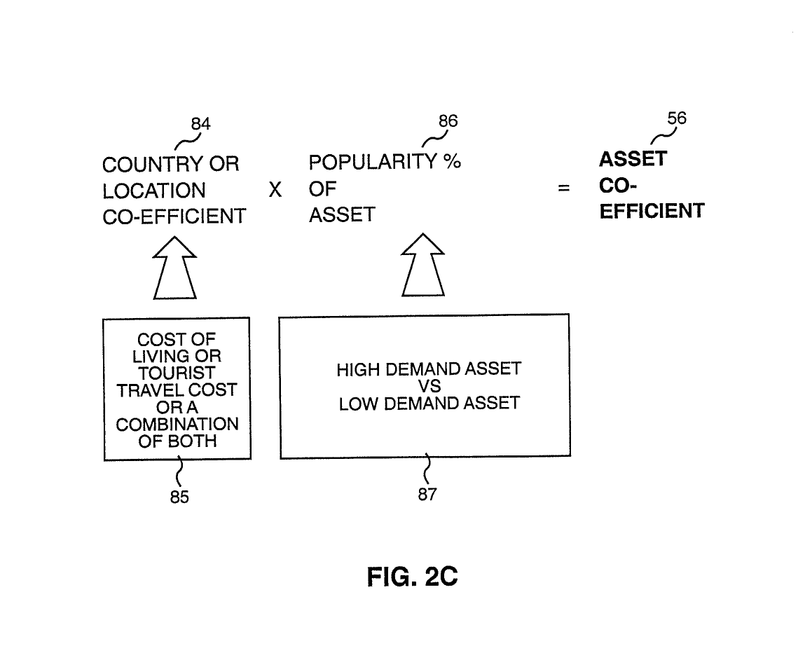

FIG. 2 is a flowchart showing the steps of registering an asset owner with asset converter of the present invention. In step 32, the asset owner is presumed to buy via traditional means from an asset developer/operator a redeemable asset. In a context of timeshare intervals, the asset owner 5 bought a specific timeshare interval from a resort developer 10 or a marketing agent 15 for such a resort. As part of the standard usage procedure, the resort issues the asset owner 5 with an identity number ID and a password for accessing the asset converter 20 or alternatively, the asset owner 5 can register online on his or her own. After obtaining the ID and the password in step 34 the asset owner 5 enters personal information and possibly changes the password given by the resort developer 10. Next, the asset owner 5 submits his asset information (i.e., timeshare interval details) online to the asset converter 20 in step 36. The asset information is validated real-time against information provided by the asset developer 10 or asset intermediary 15. If it does not match, the asset owner 5 will be notified and the information routed to the asset intermediary for verification or correction in step 41. When the asset information is verified to match with that stored in the database of the asset developers 10 or asset intermediaries 15, step 38 advises the asset owner 5 to pay for usage fee for the asset converter in order to activate his or her membership with the asset converter 20. Once the asset owner 5's payment is verified, his personal and asset information shall be forwarded and stored in an asset owner's database with the asset converter 20 in step 40. Thereafter in step 42, the asset converter 20 sends ownership/membership confirmation information to the asset owner 5 via the communication link or otherwise in step 44. The preceding constitutes the registration procedure of enrolling the asset owner 5 under the present invention.

FIGS. 2A-2C are flowcharts describing the process of deriving an adjusted asset points-based or token system for facilitating the conversion of any redeemable assets in the present invention. Depending on the nature of the redeemable asset, any such asset can be converted by the present invention for its entire life or usage, e.g., credit card reward points, hotel rewards programs and frequent flyer mileage or a periodic usage, e.g., timeshare intervals. Furthermore, a periodic usage can be current or future. In the preferred embodiment of the present invention, the points-based or token system 50 comprises six components: an asset base point module 52, a member feedback module 54, an asset co-efficient module 56, an adjusted asset token module 58, a plurality of seasons factor modules 60, 62 and 64; and a weekday and weekend token classification 66, 68, 70, 72, 74 and 76. Each asset, such as timeshare interval, frequent mileage, credit card loyalty points, hotel rewards programs or any redemption program units, can be evaluated according to a points-based or token system similar to 50 in order to generate a normalized aggregate total of an asset owner 5's account after he or she registered with the asset converter 20. Depending on the type of redeemable asset, the points-based or token system described in FIGS. 2A-2C may not be applicable. However the rest of the present invention is.

FIG. 2B is an example of how a redeemable asset can be assessed transparently in accordance to asset-based points 52 according to a plurality of composite inputs. Using a timeshare interval as a concrete example, the basic asset feature of a resort development is given a certain number of points in step 78. Furthermore, the assigned unit's features is similarly assessed in step 80 and given a certain number of points or tokens. Finally, the thematic experience of the asset is graded in accordance with a points-based or token system in step 82. The points from steps 78, 80 and 82 are aggregated to derive at the asset base points 52. Referring again to FIG. 2, the asset base points 52 are measured against members' feedback and multiplied with a factor. Last but not the least, the asset base point 52 and the member feedback 54 are further adjusted for a weightage factor asset co-efficient 56. The mechanics of deriving the asset co-efficient 56 is illustrated in FIG. 2C where country location co-efficient 84 and popularity factor of asset are two key components of this factor.

Although FIGS. 2A-2C describing in particular details on how a points-based system may be applied to prepare a redeemable asset such as resort interval for conversion and trading, it should be understood by one skilled in the art that other redeemable assets such as frequent flyer mileage, credit card loyalty points, hotel rewards programs and other illiquid assets may be similarly evaluated. It follows that a broad class of redeemable assets may be consistently and transparently evaluated according to the points-based system described in FIGS. 2A-2C. Another novel feature of the present invention is the automatic conversion of the aggregate of the points-based system into tokens. Tokens are digital units that facilitate converting and buying redeemable assets over the communication channels of the present invention. An application of the points-based system and the use of digital token in an online environment shall be illustrated by way of an example of a trading transaction in FIGS. 4A-4L respectively.

It is shown that the multi-variable points-based system of the present invention as illustrated in FIGS. 2A-2C encompasses most of the common factors for evaluating redeemable assets. As such, it is an even-handed and transparent approach to assess the convertibility of a broad range of redeemable assets such as timeshare intervals, frequent flyer mileage, credit card loyalty points, hotel rewards programs and other benefits of customer reward programs. While the present invention solves the liquidity issue with respect to converting redeemable assets with the asset converter 20 facility via the internet, the use of digital tokens as a secured currency equivalent in an online environment as shown in FIG. 1 tackles the latent problems that other redeemable asset owners encounter with existing prior art methods and systems.

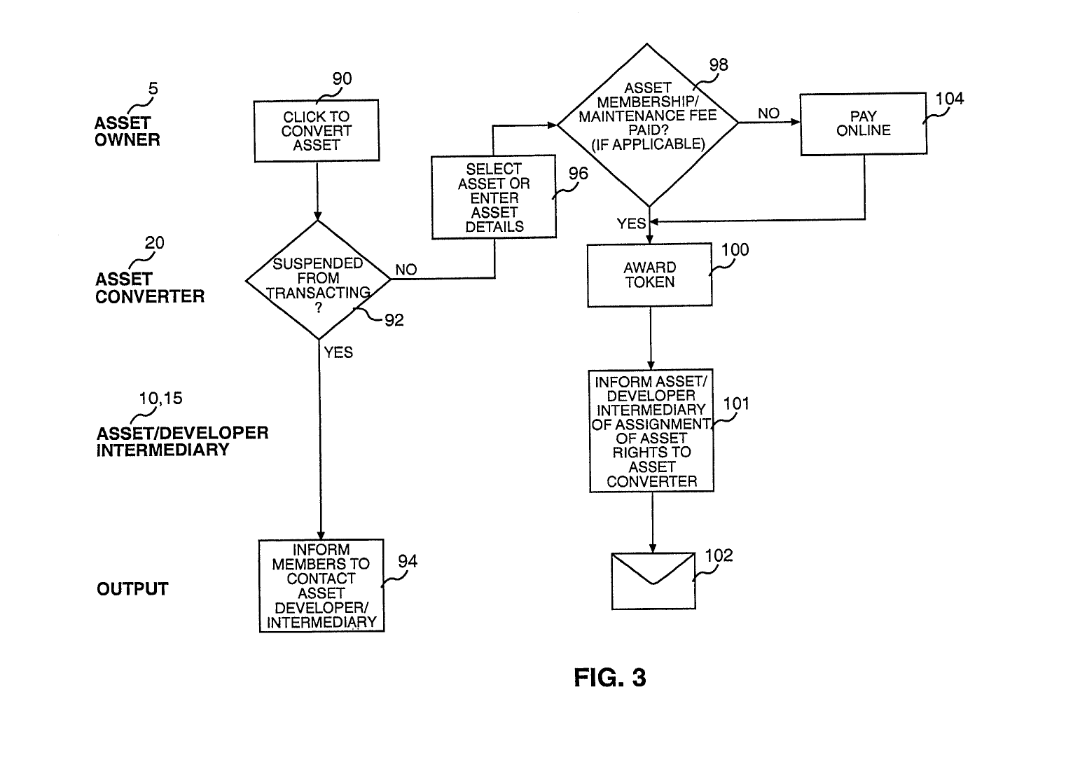

FIG. 3 is illustrative of the steps for an individual asset owner to convert a redeemable asset with the asset converter of the present invention. In step 90, an asset owner 5 is presumed to register at least one redeemable asset with the asset converter 20 of the present invention before he or she is eligible to convert a redeemable asset. Through an interface that is similar to the ones shown in FIGS. 4A-4L, the asset owner 5 activates the conversion function of the asset converter 20 by dicking a conversion button on the website. Responsive to this input by the asset owner 5, the asset converter 20 in step 92 counterchecks with a database (not shown in FIG. 3) of suspended redeemable assets belonging to the asset owners. The database of suspended assets can reside with the converter 20. However, it can also be co-located with the asset developer 10, the asset intermediary 15 and/or the asset validator 25. If the asset owner's redeemable asset corresponds with a record of suspended assets, the asset owner will be advised to contact either the asset developer 10 or the asset intermediary 15 in step 94 to resolve any outstanding matters. If the redeemable asset in step 92 is not found in the database of suspended assets, then the asset owner is prompted to provide details of redeemable assets in step 96.

Referring again to FIG. 3 and once the asset owner provides details of the redeemable asset for conversion, the asset converter 20 counter checks with the asset validator 25 whether the membership/ownership and periodic dues/maintenance fee status of the redeemable asset is current in step 98. If it is, the asset converter 20 converts the redeemable asset according to the points-based system described above in FIGS. 2A-2C and awards to the account of the asset owner 5 a predetermined number of tokens in step 100. Thereafter, in step 101, the asset converter informs the asset developer/intermediary of the conversion and/or assignment. This is necessary to prevent further conversion of the usage of the assets. The database of asset owner with the asset converter 20 is updated with the assignment of asset rights of the asset owner. Next in step 102, the asset owner is appraised of the number of tokens he or she is entitled to. However, if the ownership/membership or periodic dues/maintenance fee of the redeemable asset is not current/paid, the asset owner will be asked to update/settle online as shown in step 104. The roles of the asset developers 10, the asset intermediary 15 and the asset validator 25 are highlighted in the process of describing the conversion of a redeemable asset in FIG. 3. They are critical in verifying the status and convertibility of redeemable assets that are placed with the asset converter 20. Without their confirmation whether an asset owner has kept his or her redeemable asset current, the present invention will not be as responsive as otherwise.

FIG. 4 is representative of the process for an individual asset owner to search and buy a redeemable asset with the asset converter of the present invention. The asset owner 5 searches and browses for suitable redeemable assets in step 120 with at least one web page of the asset converter 20. Examples of such interfaces are shown in FIGS. 4A-4C respectively. Next, in step 122, the asset owner 5 selects a redeemable asset meeting his or her criteria and adds to the shopping cart. FIG. 4D is an example of the selection process summarized in step 122. Thereafter, the asset owner 5 may assign in step 124 the selected redeemable asset to his or her guest provided that it meets with the requirements of the asset developer 10 as illustrated in FIG. 4E. The asset owner 5 follows by paying the transaction fee to the asset converter 20 in step 126. The asset converter 20 returns with a confirmation of the purchase and/or assignment in step 128. A confirmation e-mail is sent for record purpose to the asset owner in step 130. The confirmation is followed by the printing of the certificate of purchase or assignment in step 132. Thereafter in step 133, the asset converter 20 informs the asset developer/intermediary of the extent of the buyer's rights and privileges. Next, a congratulation message and update of token balance appears with the status of the asset owner's account in step 134. For instance, where the asset owner assigns the bought redeemable asset to a guest, the contents of the congratulation message is directed to the guest in step 134. Optionally, the congratulation message in step 134 is directed to the assigned guest in step 136.

As mentioned in the description of FIG. 4, the asset owner 5 searches and browses for redeemable assets with the web page of the asset converter 20. In FIG. 4A a specific example of a timeshare interval trading portal is illustrated. A web page 140 is shown to feature menus 141, 142, 143, 144,145,146, 147 and 148 respectively. In the preferred embodiment of the present invention, the web page 140 is an advanced resort search interface. The “Buy” menu 141 permits the user to buy resorts intervals from the inventory of the asset converter; the Register menu 142 allows the user to sign up and become member of the asset converter. Similarly, the Rent menu 143 facilitates the transfer of rental resort intervals. Once the registration is completed, the user will have an account; through the Member menu 144, the asset owner receives status and update of his or her account. Resort Directory Menu 145 is a list of particulars of redeemable assets in the asset converter's domain. Convert menu 146 enables the asset owner to convert and trade his or her redeemable assets. Partner menu 147 links the user to the asset developers, resorts and asset intermediary of the present invention. Finally, the Shopping cart menu 148 directs the user to a temporary space for recording redeemable assets that the owners wish to trade.

Referring again to FIG. 4A, the interface 140 provides automatically a member with a balance of the number of tokens he or she has in 150 before he or she browses or searches for other resort intervals or redeemable asset to buy. A typical search criteria interface for example features country 152, city/state/province 154, type of experience 156, kind of resort 158, resort rating 160, occupancy 162, number of tokens needed 164, and finally the preferred travel periods 166 and 168 respectively. Once a member (in this example, who has a total number of 265224 tokens) provides the intelligent interface 140 of the asset converter 20 with the requisite preference information, he or she is encouraged to dick on a Continue button 170 to launch the search function.

FIG. 4B shows a typical result of the search request submitted by the user in FIG. 4A. In the preferred embodiment of the present invention, a resort Duta Vista in Kuala Lumpur, Selangor, Malaysia satisfied the search criteria of the member. An Available Intervals button 173 provides the next level of option for the member of the asset converter to decide. Clicking or activation of this bit map area leads the member to FIG. 4C where a detailed listing 174 of the intervals of Duta Vista resort is provided. In the instance example, the member selects three intervals 176, 178 and 180 for consideration. An Add To Genie Cart button 183 on the listing interface 174 permits the member to gather the selected intervals into the Genie cart 148. In FIG. 4D, the Genie Cart 148 is updated with the three choices that the member made earlier. Note that the member's token balance 150′ is updated automatically. In other words, his previous token balance 150—265224—is reduced to 256524 because his purchase of three intervals 176, 178 and 180 costs him 8700 tokens and this subtotal is subtracted from the previous token balance. A billing information area 181 summarizes the number of tokens consumed in the member's latest purchase. Note, that the transaction fee 186 is partially waived for the member by the amount shown in 182, as this is one of the privileges of registering with the asset converter.

Again in FIG. 4D, an “Assign Guest” button 185 is provided so that the member may assign his bought privileges to friends, relatives and associates. FIG. 4E is an interface 124 that appears when the member clicks the button 185. This Assign Guest interface provides the member with the flexibility of assigning his guest virtually. In the past, the procedures of assigning guest of redeemable assets are cumbersome and unpredictable. In the preferred embodiment of the present invention, the interface 124 has a Assigning Guest box 188 for providing the asset converter 20 with the guest's full name 190, address 192, identification 194 and 196. Clicking on a “Assign Guest Now” button 198 automatically generates the confirmation and printing of guest certificate as outlined in steps 132 and 133 in FIG. 4. FIG. 4F is another screen capture of the Genie cart 148′ with the updated information of the intervals being assigned to a guest. Here, the billing information reflects a charge of a guest fee 200 for assigning the interval to a guest of a member of the asset converter. A “Pay By Credit Card” button 202 is provided so that the member can pay the fee with his or her credit card. It should be noted that this guest fee 200 is payable to the asset validator 25 and as the case may be the asset intermediary 15 and the asset developer 10 respectively.

FIG. 4G is search interface of the asset converter targeted for rental assets. The interface 143 is substantially similar to that for buying intervals in FIG. 4A. FIG. 4H shows the search result following a search request from a member of the asset converter. The search result 204 of FIG. 4H also has a “Check Available Intervals” button 205 similar to that for FIG. 4B. FIG. 41 displays a list of available rental intervals in response to the member clicking on the “Check Available Intervals” button. In the specific example of the preferred embodiment, the member decides to rent one interval 208 from the list of rental interval. The interface 206 features an “Add to Genie Cart” button 212 that allows the member to accumulate the selected rental intervals in the Genie cart.

FIG. 4J is a refreshed interface 148″ of the Genie cart; it not only captures the previous purchase of intervals but also incorporates the latest rental of intervals. The member's tokens 150″ remains the same because the rental of intervals 214 and 216 requires the member to pay via either cash or credit card. The billing information area shows a positive entry under rental fee 220; it also captures the total amount payable 222. A “Pay By Credit Card” button 224 is conveniently provided by the interface 148″ to facilitate the easy settlement of transactions of redeemable asset with the asset converter. The button 224 activates the payment interface 148′″ where the total amount payable 222, credit card type 224, credit card number 226 and expiry date 228 are requested. Finally, a summary 134 in FIG. 4L of the transaction is displayed before the member leaves the asset converter or proceeds to another new transaction. A transaction certificate 230 is printed for the benefit of the member.

Although the previous description of the present invention concerns the trade and rental of redeemable assets, the present invention features other value-added facilities, e.g. one-to-one swap, classified rental, consignment, auction and firesales. FIG. 5 is a flowchart showing the steps of an enhanced one-to-one swap of redeemable assets of exclusive assets with the asset converter of the present invention. By exclusive asset or premium asset developers, the present invention refers to a class of asset developers that have a very high token value or worth. Alternatively, membership for such assets is based on criteria that are not unusual.

Again, in FIG. 5, the owner of a redeemable asset receives privilege invitation and password in step 240. The asset converter requests in step 242 to confirm the asset information. If it is not confirmed, then the asset converter attempts to update its asset information database in step 244 and informs the owner in step 246 that the asset information has not been confirmed. Then in step 248, the asset validator 25 attempts to validate the asset information manually. Should the asset developer 10 or the asset intermediary 15 disconfirm the asset information, the owner will be notified in step 252. No further swapping of redeemable asset shall occur. However, if the asset converter 20 confirms the asset information in step 242, then the owner shall b e requested to specify the target asset or destination resort in step 254. Next, in step 256, a search will be initiated automatically in step 256 based on the owner's criteria. If a match is found and the owner satisfied with the result and intervals, the owner pays the processing fee in step 258. The asset converter 20 returns a congratulation message in step 262. If no match is found after a search in step 256, the asset converter 20 posts the owner's request on a swap billboard in step 264 and requests the member to pay a listing fee. The owner shall be informed timely of the posting in step 260. If a match is realized, the asset intermediary 15 is informed in step 266 and the member executes a swap of exclusive assets.

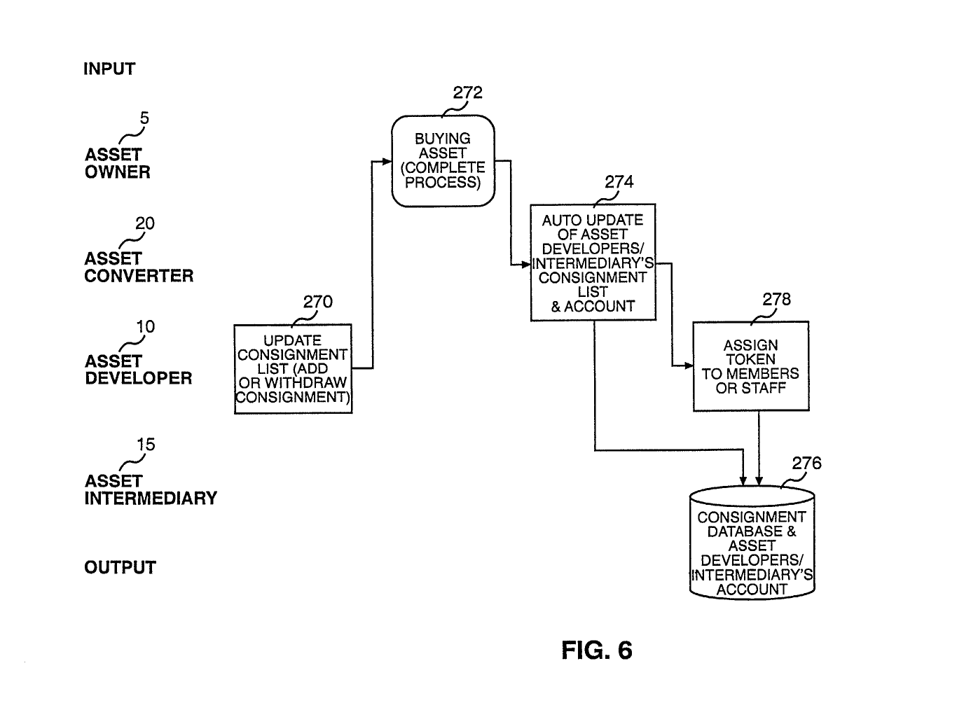

FIG. 6 shows in block diagrams the steps for asset developers 10 or asset intermediaries 15 to offer on a consignment basis sale of redeemable assets with the asset converter of the present invention. The asset developer 10 or asset intermediary 15 updates the consignment database with the asset converter 20 in step 270. Asset owners 5 buy the assets via the asset converter 20 without knowing such assets were on a consignment basis or not in step 272 and complete the transactions. Next, the asset converter 20 updates the consignment database automatically once the asset owners buy the asset in step 272. Next, with the tokens from the consignment sale of the assets, the asset developers 10 can offer as incentive to its own members or staff in step 278. Once again, the consignment database is updated by the asset converter once the tokens are transferred to owners or employees or nominees of the asset developers.

The consignment sale of redeemable asset via the asset converter is one of the novel features of the present invention. On one hand, it allows the asset developers to market its under utilized assets anonymously via the asset converter thus maximizing the utilization or occupancy of its assets. On the other hand, it gives the asset owners of the asset converter a larger pool of redeemable assets to choose from. Finally, the asset converter generates extra revenue for itself and the asset developers. In other words, the consignment sale of redeemable assets by the asset developers via the asset converter is a win-win solution for all concerned. It is hoped that this among other value added services will enable the redeemable asset industry to achieve greater impact in the market place with the present invention.

The present invention may be embodied in other specific forms without departing from the spirit or essential characteristics thereof. The presently disclosed embodiments are, therefore, to be considered in all respects as illustrative and not restrictive, the scope of the invention being indicated by the appended claims and all changes which come within the meaning and range of equivalency of the claims are, therefore, to be embraced therein.

We claim:

1. A method facilitated by a computer network to accomplish a trusted transaction between a redeemable asset environment and a networked asset owner, comprising the acts of:
providing an asset converter having a communications channel for electronically communicating with said environment and having a communications channel for electronically communicating with said asset owner;
providing an owner registration system in said converter wherein a database of owners and associated redeemable assets reposed, said converter authenticating said owners and designating each said owners a registered owner;
allowing said registered owner to selectively access said converter to submit preference of redeemable assets said registered owner wishes to trade, said converter searching through said database and reverting with a list of assets matching said preference, said registered owner selecting a predetermined number of matched assets, said converter converting automatically said redeemable assets into predetermined number of digital tokens; and
permitting said registered owner to trade redeemable assets within said database with said digital tokens, the contents of said registered owner's redeemable assets being verified by an asset validator prior to delivery and receipt of the rights of selected matched assets,
whereby said method facilitates the trading of redeemable assets transparently and economically.

2. The method for accomplishing transaction between a redeemable asset environment and a networked asset owner in claim 1 wherein said asset converter is an administrative server having at least one communication channel with said validator.

3. The method for accomplishing transaction between a redeemable asset environment and a networked asset owner in claim 1 wherein said redeemable assets are converted to digital tokens in accordance to a predetermined composite points-based system.

4. The method for accomplishing transaction between a redeemable asset environment and a networked asset owner in claim 3 wherein said composite points-based system correlates the desirable features and seasonality of the assets underlying said redeemable assets.

5. The method for accomplishing transaction between a redeemable asset environment and a networked asset owner in claim 1 wherein said converter verifies and updates its database of registered owners and asset rights by counter checking similar databases of asset developers and/or asset intermediaries.

6. The method for accomplishing transaction between a redeemable asset environment and a networked asset owner in claim 1 wherein said validator is an administrative server having a communication channel with said converter and said registered owner.

7. The method for accomplishing transaction between a redeemable asset environment and a networked asset owner in claim 6 wherein said validator provides verification information to said converter for verifying, validating and/or suspending the rights of said registered owner to trade redeemable assets if appropriate ownership/membership and periodic dues/fees or creditworthiness is not regularized.

8. The method for accomplishing transaction between a redeemable asset environment and a networked asset owner in claim 1 wherein said asset converter and the asset validator are the same.

9. A method facilitated by a computer network to accomplish a trusted transaction between a redeemable asset environment, at least one asset developer and a networked asset owner, comprising the acts of:
providing an asset converter having a communications channel for electronically communicating with said environment and having a communications channel for electronically communicating with said asset developer and asset owner;
providing an owner registration system in said converter wherein a database of owners and asset developers and associated redeemable assets reposed, said converter authenticating said owners and designating each said owners a registered owner;
allowing said registered owner to selectively access said converter to submit preference of redeemable assets said registered owner wishes to trade, said converter searching through said database and reverting with a list of assets matching said preference, said registered owner selecting a predetermined number of matched assets, said converter converting automatically said redeemable assets into predetermined number of digital tokens;
providing said asset developer access to said converter to offer its inventory of redeemable assets for trading; and
permitting said registered owner to trade redeemable assets within said database with said digital tokens, the contents of said registered owner's redeemable assets being verified by an asset validator prior to delivery and receipt of the rights of selected matched assets,
whereby said method facilitates the trading of redeemable assets transparently and economically.

10. The method for accomplishing transaction between a redeemable asset environment and a networked asset owner in claim 9 wherein said asset converter is an administrative server having at least one communication channel with said validator.

11. The method for accomplishing transaction between a redeemable asset environment and a networked asset owner in claim 9 wherein said redeemable assets are converted to digital tokens in accordance to a predetermined composite points-based system.

12. The method for accomplishing transaction between a redeemable asset environment and a networked asset owner in claim 11 wherein said composite points-based system correlates the desirable features and seasonality of the assets underlying said redeemable assets.

13. The method for accomplishing transaction between a redeemable asset environment and a networked asset owner in claim 9 wherein said converter verifies and updates its database of registered owners and asset rights by counter checking similar databases of asset developers and/or asset intermediaries.

14. The method for accomplishing transaction between a redeemable asset environment and a networked asset owner in claim 9 wherein said validator is an administrative server having a communication channel with said converter, said asset developer and said registered owner.

15. The method for accomplishing transaction between a redeemable asset environment and a networked asset owner in claim 14 wherein said validator verifies asset information with said asset developer before reverting to said converter.

16. The method for accomplishing transaction between a redeemable asset environment and a networked asset owner in claim 9 wherein said validator provides verification information to said converter and said asset developer for verifying, validating and/or suspending the rights of said registered owner to trade redeemable assets if appropriate fees or creditworthiness is not regularized.

17. The method for accomplishing transaction between a redeemable asset environment and a networked asset owner in claim 9 wherein said asset developer offers its inventory of redeemable assets on said converter on a consignment basis.

18. The method for accomplishing transaction between a redeemable asset environment and a networked asset owner in claim 9 wherein said converter collects on behalf of said asset developer and validator periodic dues/maintenance and processing fees whenever said registered owner trades redeemable asset on said converter.

19. The method for accomplishing transaction between a redeemable asset environment and a networked asset owner in claim 9 wherein said asset converter and the asset validator are the same.

20. The method for accomplishing transaction between a redeemable asset environment and a networked asset owner in claim 9 wherein said asset developer and an asset intermediary are different entities, said asset intermediary comprises of asset management companies, asset operators, custodians of assets, trustees and associations of asset owners.
